(19) United States
(12) Patent Application Publication
(10) Pub. No.: US 2026/0243322 A1
(43) Pub. Date: Aug. 20, 2026

(54) Silicone Resin-Based Friction Lining Mixtures and Friction Linings Containing Metal Fibers

(71) Applicant: TMD Friction Services GmbH, Leverkusen (DE)

(72) Inventors: Rolf GONDRUM, Reken (DE); Georg MÜLLER, Essen (DE); Philipp NYHOF, Solingen (DE); Xabier UGARTE, Köln (DE)

(73) Assignee: TMD Friction Services GmbH, Leverkusen (DE)

(21) Appl. No.: 19/159,833

(22) PCT Filed: Feb. 15, 2024
(86) PCT No.: PCT/EP2024/053823

§ 371 Date: Aug. 26, 2025

(30) Foreign Application Priority Data
Mar. 17, 2023 (DE) 10 2023 106 699.4

(51) Int. Cl. F16D 69/02

(52) U.S. Cl. CPC F16D 69/026; F16D 2200/0065; F16D 2250/0023

(57) ABSTRACT

Friction linings for use in motor vehicle braking systems, which are produced using silicone resins, metal fibers made from soft iron compounds and/or steel compounds, fillers, and abrasive grains, are characterized by high thermal and mechanical resistance.

### CROSS-REFERENCE TO RELATED APPLICATIONS

This application is a national stage application (under 35 USC § 371) of PCT/EP2024/053823, filed Feb. 15, 2024, which claims benefit of DE 10 2023 106 699.4, filed Mar. 17, 2023, the contents of each of which is incorporated by reference herein.

### BACKGROUND OF THE INVENTION

The present invention relates to silicone resin-based friction lining mixtures and friction linings, in particular for disc brake linings, a method for their manufacture and their use.

Silicone resin-based binder systems and friction linings are known in the prior art.

EP 2 310 714 B1 discloses a brake lining for disc brakes that has a friction section made of a ceramic matrix material. This ceramic matrix material is made from a silicon ceramic base material, particles of hard materials that serve as abrasives, particles of substances suitable as lubricants, and particles of metal materials.

DE 11 2009 000 893 T5 describes compositions for brake linings based on silicone resin and NBR rubbers.

U.S. Pat. No. 5,984,055 relates to friction linings comprising a fiber-reinforced ceramic matrix material comprising a ceramicizable resin and fibers.

U.S. Pat. No. 8,960,384 B2 discloses a method for producing ceramic matrix material for friction linings, wherein a silicone-containing ceramic precursor, abrasives, lubricants, and metal particles serve as starting materials.

DE 101 30 395 A1 discloses a friction material in which the base component is formed from fiber material such as copper or brass. An additional infiltration component can consist, for example, of phenolic resin, soft metal, or glass.

DE 697 18 346 T2 refers to a friction material with a sintered mass of iron in which graphite particles are dispersed. The mass contains iron in the form of fibers and particles.

Finally, WO 2013/076744 A1 describes a friction material for disc brakes comprising 1-8% of a ceramicizable resin and 2-10% of an organic resin. A silicone resin can be used as a ceramicizable resin.

These silicone resin-based binder systems or friction linings generally represent an improvement over conventional friction linings described in the prior art. However, there is still room for improvement in the performance characteristics of these linings in high-performance applications, i.e., particularly at high pressures and temperatures.

### SUMMARY OF THE INVENTION

An aim of the present invention was therefore to provide friction linings and friction lining mixtures which are improved in particular with regard to the parameters of abrasion, coefficient of friction, and pressure and temperature resistance in relation to the prior art.

It has been found that special silicone resin-based friction lining mixtures or friction linings made from them can meet these increased requirements and, at the same time, do not impose any additional requirements or modifications on the production methods known from the prior art.

In order to achieve the above objectives, the friction lining must be physically highly compacted and at the same time have a high chemical density of chemical bonds and polar interactions between its components. In this context, the creation of a high chemical density of chemical bonds between the various components of the friction lining is particularly important and therefore requires special measures to ensure that this is achieved.

### DESCRIPTION OF THE DRAWING

FIG. 1 shows images at various magnifications of the steel fibers M1 (left), M2 (middle), and M3 (right) with approximate scale, in which M1, M2 and M3 have the compositions set forth in Table 1.

### DETAILED DESCRIPTION

The inventive, highly abrasion-resistant and friction coefficient-optimized silicone resin-based friction lining mixtures or friction linings preferably have the following composition. Unless otherwise specified, the following information here and later refers to % by weight based on the finished friction lining mixture:

| | |
|---|---|
| Metals (e.g., fibers, mostly ferrous) | 5-90% |
| Friction grains/friction agents | 25-45% |
| Fillers (especially coke) | 5-40% |
| Lubricants | 0-20% |
| Cross-linking chemicals/catalyst (such as zinc organics) | 0.1-4% |
| Silicone resins | 6-16% |

Metals such as Fe or Cu or mixtures thereof, alloys, or sintered metals ensure a high coefficient of friction even at elevated or high temperatures and at the same time ensure good wear characteristics. A preferred component is metal fibers with a proportion of preferably 5-90%, in particular 5 to 30%, in the friction lining mixture according to the invention. Iron or steel fibers are preferred here, as they increase the strength of the mixture or friction lining and prevent individual components from breaking out of the friction lining. Copper or copper fibers are less preferred due to their unfavorable environmental properties. Cu-free friction lining mixtures or friction linings are therefore also covered by the present invention.

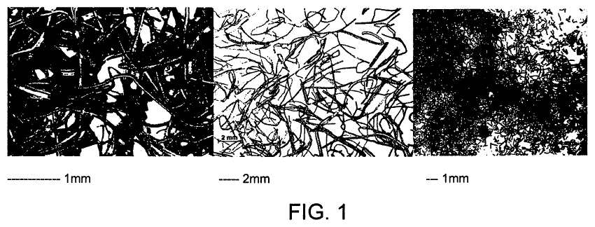

Advantageously, unwanted premature abrasion of the friction material can be reduced by using special iron or steel fibers in the silicone resin-based mixture (FIG. 1 Use of M2 or M3). These are fibers made of relatively soft iron or steel. It has been shown that special iron fibers produced with a reduced amount of alloying elements exhibit particularly good properties with regard to abrasion (M2). The carbon, manganese, and silicon content are particularly noteworthy here (see Table 1). This is why they are also referred to as pure iron fibers or, according to the invention, as soft iron compounds or soft iron fibers (preferably compounds of type M2 according to Table 1).

Structurally, the fibers are characterized by the fact that they preferably only contain ferrite phases. In addition to ferrite phases, the steel fibers with alloying elements also exhibit clearly defined pearlite structures. These pearlite structures make the iron particularly strong. These iron-carbon alloys are also referred to as solid steel.

According to the invention, steel fibers of type M3 according to Table 1, which are referred to here as soft steel fibers or soft steel compounds, are preferred.

In addition to the proportion of alloying elements, the strength of steel is also increased by its elongation. The elongation can be recognized by elongated crystalline structures. If the fibers are then hot-set, the strength gained from this process is lost. The use of special hot-work hardened steel is therefore particularly advantageous according to the invention. This is because excessive strength tends to be detrimental to reducing abrasion. The differences can also be determined based on the differences in hardness, see (M1) and (M3) in FIG. 1.

TABLE 1
Composition and dimensions of iron fibers or steel fibers M1, M2, M3

| | | | Carbon | Mn | Si | | |
|---|---|---|---|---|---|---|---|
| | | Hardness | [% by | [% by | [% by | Length | Thickness |
| Type | Specification | [HV] | weight] | weight] | weight] | [mm] | [mm] |
| M1 | Cold-worked | 225 (+/−35) | 0.1 | 1 | 0.1 | 3-3000 | 0.001-0.1 |
| | steel fibers | | | | | | |
| M2 | Pure iron | 245 (+/−10) | 0.003 | 0.078 | 0.021 | 3-3000 | 0.001-0.1 |
| | fibers | | | | | | |
| M3 | Hot-worked | 80 (+/−20) | 0.1 | 0.8 | 1 | 0.1-50 | 0.001-0.1 |
| | steel fibers | | | | | | |

M1: STAX steel fiber (unalloyed) Manufacturer: GERMAN METAL FIBER PLANT Dr. Schwabbauer GmbH & Co. KG.
M2: STAX Pure Iron Fibers Manufacturer: GERMAN METAL FIBER PLANT Dr. Schwabbauer GmbH & Co. KG.
M3: annealed steel fibers; American Metal Fibers, Inc.

TABLE 2
Wear/abrasion on linings with different metal fiber compositions

| | Ref. | Example 1 | Example 2 | Example 3 |
|---|---|---|---|---|
| Catalyst | 0.2 | 1 | 1 | 1 |
| Abrasive grain | 21 | 34.9 | 34.9 | 34.9 |
| Lubricants | 10 | 4.4 | 4.4 | 4.4 |
| Coke | 30 | 16 | 16 | 16 |
| Resins | 7.8 | 9.9 | 9.9 | 9.9 |
| Metals (M1) | 31 | 33.3 | 12.3 | 12.3 |
| Metals (M2) | | | | 21.0 |
| Metals (M3) | | | 21.0 | |
| Wear in flywheel | 3.02 | 3.02 | 2.98 | 2.63 |
| dynamometer test (Spa | | | | |
| Simulation) [mm] | | | | |

Wear is determined by measuring the thickness of the lining at several points before and after the measurement.

For linings with only M1 fibers, the abrasion value is the same as for the reference (Ref), i.e., a conventional lining. Linings with additional proportions of M2 and M3 fibers exhibit lower abrasion; see Table 2.

Preferably, the metal fibers are predominantly, i.e., more than 50%, made of soft iron and/or soft steel compounds. These may be pure iron fibers or hot-strength steel fibers in particular. It is also conceivable to mix pure iron fibers or hot-strength steel fibers. The metal fibers used in the invention are preferably made of more than 60% soft iron and/or soft steel compounds.

The friction lining mixtures/friction linings according to the invention contain a high proportion of friction agents, preferably in the form of friction grains, also referred to collectively as abrasive materials. Preferred representatives are SiC (6.4 μm), ZnO (2.5 μm), MgO (12.7 μm), Al₂O₃ (5 μm), and various silicates, to name the most important ones. The preferred d50 values for particle sizes are shown in brackets. The d50 value means that 50% of the particles are smaller in size. The value is determined by light scattering. The size of the particles is determined by dynamic light scattering from a suspension of the particles.

The coke listed in the description is referred to as an active filler. Active fillers are materials whose surfaces have the best possible affinity with the cross-linking chemicals used, especially with the silicone resin, resulting in greater cross-linking between the friction lining components and ultimately a higher density of the finished friction linings. Examples of preferred active fillers according to the invention include petroleum coke (calcined) or carbon black.

Here, active fillers are classified according to their ability to form a chemical bond with the silicone resin. Active fillers are characterized by the fact that, firstly, they can react with the resin due to their functional groups on the surface and, secondly, their comparatively high specific surface area (the coke used has a specific surface area of preferably >0.9 m²/g) offers many opportunities for bonding with the resin. The specific surface area of the particles is determined by BET measurements.

The remaining materials in the friction lining mixture must be enclosed by a highly cross-linked matrix, as the active, i.e., intrinsic chemical bonding of these remaining materials to the matrix is insufficient due to their chemically inactive surfaces.

The lubricants used are primarily high-temperature lubricants. Examples include antimony, molybdenum, and zinc sulfides, as well as graphite.

The cross-linking chemicals or catalysts are preferably organozinc compounds (catalysts).

It is well known in the art that silicone resin-based friction linings must undergo a curing reaction (a polycondensation reaction), which can be carried out without a catalyst or preferably with appropriate catalysts. According to the invention, organic zinc compounds (zinc organils) are used for this purpose in particular. Zinc acetylacetonate, zinc pentadionate, zinc acetate, or their derivatives are particularly noteworthy in this regard.

The silicone resins suitable for use in the invention are generally crosslinked polymethylsiloxanes or polymethylphenylsiloxanes or polyphenylsiloxanes commonly used in technology with the structural element of formula I

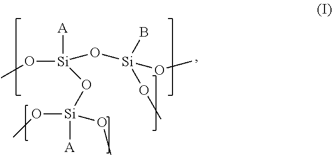

in which A and B can represent different organic radicals (identical or different), such as methyl, ethyl, or phenyl. Such silicone resins are usually sold in pre-condensed form. In some cases, they are also combined with phenolic and polyester resins to further improve surface hardness and resistance to heat and chemicals, for example. All of the silicone resins mentioned above are fundamentally suitable for use in the invention.

Silicone resins with a high inorganic content are particularly preferred. The inorganic content can be up to approx. 82% by weight. The inorganic content is defined as the proportion remaining after calcination of the pure resin sample. The organic content in the resin is necessary because the resin must melt during pressing. This is ensured by a certain amount of organic residues in the resin. The organic residues in the resin consist of phenyl and/or alkyl groups. Alkoxy groups may also be part of the organic content of the resin. Ethoxy groups and methoxy groups are preferred as organic side groups of the resin.

The resin content (silicone resin content) in the mixture is preferably between 6% and 16% by weight (based on the finished friction lining mixture). Such suitable resins are sold, for example, by Wacker Chemie AG, Germany, under the brand name Silres®. The preferred resin here is Silres MK.

The relatively low organic content preferred according to the invention ensures that the matrix (i.e., binder system and fillers) of the friction lining remains largely intact even when the organic components are degraded. Silicone resins with a significantly higher organic content show significantly higher weight loss at elevated temperatures, which means that the matrix is significantly degraded and, at the same time, the abrasion values increase unfavorably. The degradation of the organic matrix can be easily and reliably monitored and determined using thermogravimetric analysis (TGA).

Another advantage of the silicone resins suitable according to the invention is their low softening temperature, which is preferably between 35° C. and 55° C. This low softening temperature is advantageous, for example, when pressing the friction lining mixture to form a pre-crosslinked friction lining compact, as this allows a lower temperature to be selected for shaping.

A low temperature results in low gas pressure within the lining during shaping.

However, according to the invention, the use of the aforementioned catalysts is preferred, preferably in an amount of 0.25% to 4%.

The use of silicone resin-based systems for high-temperature applications is well known. To this end, these systems must undergo a curing reaction, which can be achieved without a catalyst or with the use of appropriate catalysts. During the curing reaction, the polycondensation reaction that begins when the friction lining mixture is pressed continues. At the same time, organic residues are split off. However, different from what was known previously, due to the low curing temperature of <300° C. preferred according to the invention, the methyl groups of the resin remain in the resin and it is also likely that the hydrolysis reaction is not 100% complete. This means that residual ethoxy groups remain in the system.

The polycondensation reaction of silicone resins for use in brake linings is preferably catalyzed by organozinc compounds. During this polycondensation reaction, low-molecular substances are split off, which can lead to bubble formation and cracks in the friction lining during the pressing process of the friction lining mixture. The gases formed in the material to be pressed result in the lining being insufficiently compacted. All this has a negative effect on the abrasion and friction coefficient of such a friction lining. For this reason, gas formation should be minimized as much as possible during the pressing process.

According to the invention, the following measures, either alone or in combination, contribute to further improving the friction linings obtained.

A lower curing temperature of the lining ensures that parts of the reactive components remain on the surface of the fillers, resulting in improved bonding of the fillers to the resin system. During curing, the covalent bonds between the active fillers and the resin system are also formed.

This increases the cross-linking density of the material, firstly due to the lower porosity and secondly due to the increased cross-linking caused by the increased number of active groups remaining on the surface, which reduces the tendency of the friction lining to relax again after the pressing process and expand as a result. This also increases the overall network density in the system. A hardening temperature of <361° C. is therefore preferred. Above this temperature, the oxygen-containing groups/residues present on the surface of the calcined petroleum coke decompose. For this reason, a hardening temperature of preferably 300° C. or lower is selected according to the invention. This curing temperature has been shown to be sufficient to achieve cross-linking of the silicone resin.

During pressing, the mixture should be compacted as much as possible. This can be achieved by dispensing with ventilation steps during pressing.

A pressing time of preferably >8 min for the friction lining has also proven to be advantageous. The relatively long pressing time results in additional compaction of the lining material.

The material is compacted by cross-linking the silicone resin. A catalyst is preferred for this purpose. In order to achieve the highest possible compaction during pressing, all components that restrict the activity of the catalyst are omitted.

The mixture is produced and pressed, and the linings are ground, grooved, and hardened using standard methods known in the industry. According to the invention, the temperature during pressing is 100-170° C., in particular 140° C., and the temperature during hardening of the friction lining should not exceed 300° C.

All components of the friction lining mixture are first mixed in the specified proportions in an internal mixer. Then mixed for approx. 5 minutes at medium speed for the trough and for the swirler.

The mixture is then filled into a cavity of a high-pressure press. The cavity has the outline of the desired friction lining. The height of the lining is determined by the amount of mixture added. The lining carrier plate is placed on top of the cavity. A rising punch compresses the mixture in the cavity and presses it against the lining carrier plate. A hold-down device holds the lining carrier plate in position on the cavity.

The specific pressure is preferably between 15 N/cm² and 200 N/cm². A typical pressing time is 2-14 minutes. To achieve maximum compaction, the pressure is kept constant throughout the entire pressing cycle.

The lining is then ground down to the desired thickness.

This is followed by hardening at a temperature preferably below 300° C. The temperature is first increased from room temperature to ≤300° C. at a constant rate of 1° C./min. The temperature is then maintained at $300° C. for 180 minutes. Then turn off the oven and allow the linings to cool slowly in the oven.

The brake linings obtained are subjected to a flywheel dynamometer test to determine their wear resistance. The composition of the friction linings tested and the test results achieved are listed in Table 2. Ref. stands for a comparative brake lining or friction lining, and examples 1-3 stand for brake linings/friction linings according to the invention.

The method described for manufacturing the friction linings according to the invention is generally applicable and not limited to embodiments 1-3 (compositions in % by weight).

The present invention thus comprises the described friction lining mixtures, friction and brake linings made therefrom, methods for producing the friction lining mixtures and the friction and brake linings, as well as the use of the friction lining mixtures for producing the friction and brake linings and the use of the friction and brake linings in high-performance applications, such as 24-hour car races, under increased pressure, and at elevated temperatures.

1. In a friction lining mixture for producing a friction lining with reduced abrasion said friction lining mixture having at least one silicone resin, at least one filler, friction grains and metal fibers, characterized in that: the metal fibers consist of more than 50% by weight of soft iron and/or soft steel compounds.

2. The friction lining mixture according to claim 1, wherein the metal fibers comprise more than 50% by weight of pure iron fibers.

3. The friction lining mixture according to claim 2, wherein the pure iron fibers have a reduced proportion of alloying elements, and wherein carbon content of the pure iron fibers is less than 0.01% by weight, manganese content of the pure iron fibers is less than 0.5% by weight, and silicon content of the pure iron fibers is less than 0.05% by weight.

4. The friction lining mixture according to claim 2, wherein the pure iron fibers substantially comprise only ferrite phases.

5. The friction lining mixture according to claim 1, wherein the metal fibers comprise more than 50% by weight of hot-worked steel fibers.

6. The friction lining mixture according to claim 1, wherein the mixture contains one or more silicone resins which have an inorganic content of from 60% to 88% by weight.

7. The friction lining mixture according to claim 1, wherein the mixture contains one or more silicone resins totaling 6% to 16% by weight, based on the total mixture.

8. The friction lining mixture according to claim 1, wherein the mixture contains petroleum coke in a total amount of from 10% to 20% by weight, based on the total mixture.

9. A friction lining produced from a friction lining mixture according to claim 1.

10. A brake lining, comprising a friction lining according to claim 9.

11. (canceled)

12. A method for manufacturing a friction lining from the friction lining mixture according to claim 1, comprising the following method steps:
a) supplying the friction lining mixture,
b) filling the friction lining mixture into a press,
c) pressing the friction lining mixture in the press at elevated pressure of from 15-200 N/cm², and elevated temperature of from 100-170° C., for a duration of 8-14 min to create the friction lining,
d) removing the friction lining from the press, and
e) hardening the friction lining at a temperature of ≤300° C.

13. The friction lining mixture according to claim 1, wherein the mixture contains one or more silicone resins which have an inorganic content of about 82% by weight.

14. A friction lining mixture, comprising:
one or more silicone resins totaling about 6% to about 16% by weight, based on the total mixture;
one or more fillers;
one or more friction grains;
one or more metal fibers, wherein the metal fibers comprise more than 50% by weight of soft iron and/or soft steel compounds.

15. The friction lining mixture according to claim 14, wherein the metal fibers comprise more than 50% by weight of pure iron fibers.

16. The friction lining mixture according to claim 15, wherein the pure iron fibers substantially comprise only ferrite phases.

17. The friction lining mixture according to claim 14, wherein the metal fibers comprise more than 50% by weight of hot-worked steel fibers.

18. A method for manufacturing a friction lining from the friction lining mixture according to claim 14, comprising:
a) mixing together components of the friction lining mixture,
b) compressing the friction lining mixture in a press at elevated pressure of from 15-200 N/cm², and at elevated temperature of from 100-170° C., for a duration of at least 8 minutes to create a compact,
c) grinding and/or grooving the compact to a desired thickness to form the friction lining, and
d) hardening the friction lining at a temperature of not more than 300° C. to form the friction lining.
